(19) United States
(12) Patent Application Publication
(10) Pub. No.: US 2005/0108331 A1
(43) Pub. Date: May 19, 2005

(54) Presence tracking for datagram based protocols with search

(76) Inventor: Lawrence W. Osterman, Woodinville, WA (US)

Correspondence Address: AMIN & TUROCY, LLP, 24TH FLOOR, NATIONAL CITY CENTER, 1900 EAST NINTH STREET, CLEVELAND, OH, 44114, US

(21) Appl. No.: 10/698,568

(22) Filed: Oct. 31, 2003

(51) Int. Cl. G06F 15/16

(52) U.S. Cl. 709/205; 719/315

(57) ABSTRACT

A presence tracking architecture for datagram-based protocols. A client application seeking to know the presence or lack thereof of a device and/or service utilizes a standard protocol in a non-intuitive way to trigger notification of the device and/or service before any associated timeout expires. At first presence, a multicast message is broadcast to notify all devices. Subsequently, on-demand notification may be requested by a client application by sending directly (e.g., in unicast) to the device before its timeout has expired a message that is normally only sent in multicast. If capable, the device can then respond normally with a unicast message indicating it is on-line. If the response is not received, the device and/or service is determined to be off-line.

### TECHNICAL FIELD

This invention is related to detecting network devices, and more specifically, for architecture(s) that employ unicast and multicast messaging to detect such devices.

### BACKGROUND OF THE INVENTION

Datagram based discovery techniques typically employ sign-on and sign-off messages that are broadcast to nodes of a network during discovery processes. Several techniques also have search mechanisms built into the discovery protocol to allow control client applications to search for existing devices on the network. Since reception of datagrams is not guaranteed on a network and, because a device may be unable to transmit the sign-off message, most discovery mechanisms specify a time-out period to allow control applications to remove device nodes that are no longer present. This is especially important in wireless environments where a significant loss of datagram traffic can occur.

However, such conventional mechanisms and techniques do not provide the temporal granularity that may be required, since some applications need to know frequently whether the device is present.

### SUMMARY OF THE INVENTION

The following presents a simplified summary of the invention in order to provide a basic understanding of some aspects of the invention. This summary is not an extensive overview of the invention. It is not intended to identify key/critical elements of the invention or to delineate the scope of the invention. Its sole purpose is to present some concepts of the invention in a simplified form as a prelude to the more detailed description that is presented later.

The present invention provides for reducing network traffic related to discovering devices and/or services, and to searching for such devices and/or services.

In one aspect thereof, a mechanism of the present invention allows a client application to dynamically determine if a network device is active before its associated time-out period has expired, and applies to any datagram based protocol that has such or similar search characteristics. A “ping” operation utilizes legal protocol elements, albeit in a non-intuitive fashion to facilitate searching the device, its embedded devices, and its related services.

In another specific application/aspect thereof, the invention can be employed in connection with various protocols (e.g., the Simple Service Discovery Protocol (SSDP), and the General Event Notification Architecture (GENA) notification protocol, which are a part of the Universal Plug and Play (UPnP) suite of network protocols). UPnP control point applications track presence of a device with a granularity no finer then a 30-minute minimum granularity, as specified by the UPnP specification. The novel aspects of the present invention allow any suitable and correctly functioning UPnP device to respond to the request. For example, this technique can be applied to the Windows XP®(browser protocol, which has a “request announcement” protocol element.

If a UPnP client application requires that there be a more timely notification than provided by the existing UPnP mechanism, the following technique is applied by the client application to determine if the device is currently active on the network. UPnP specifies an M-SEARCH verb that allows a UPnP client application to search for UPnP devices. Normally this M-SEARCH verb is sent as a multicast datagram for discovering devices. However, in this situation, it is unnecessary to broadcast the request, since inappropriate usage of broadcast datagrams unnecessarily impacts the network bandwidth by transmitting the datagram to all devices in the multicast group when it is not necessary to do so. Moreover, these datagrams are more likely to be discarded by routers.

In accordance with the present invention, it is possible to send the M-SEARCH verb as a unicast datagram to a specific destination device. The destination device receives the M-SEARCH verb on its port and treats the multicast-type message as if it was a search request broadcast to all devices. The device responds with a directed search response. Thus, the M-SEARCH request is made to function as an Internet Control Message Protocol (ICMP) ping operation.

To the accomplishment of the foregoing and related ends, certain illustrative aspects of the invention are described herein in connection with the following description and the annexed drawings. These aspects are indicative, however, of but a few of the various ways in which the principles of the invention may be employed and the present invention is intended to include all such aspects and their equivalents. Other advantages and novel features of the invention may become apparent from the following detailed description of the invention when considered in conjunction with the drawings.

### BRIEF DESCRIPTION OF THE DRAWINGS

FIG. 1 illustrates a block diagram of a system communicating in accordance with the present invention.

FIG. 2 illustrates a flow chart of a discovery process in accordance with the present invention.

FIG. 3A illustrates a protocol stack of a UPnP implementation in accordance with the present invention.

FIG. 3B illustrates a subset of the UPnP protocol stack of FIG. 3A used to send and receive advertisements in accordance with the present invention.

FIG. 3C illustrates a subset of the UPnP protocol stack of FIG. 3A used to advertise characteristics of the target object in accordance with the present invention.

FIG. 3D illustrates a sample UPnP protocol stack used to send a multicast-type discovery datagram in unicast in accordance with the present invention.

FIG. 4 illustrates a flow diagram between a UPnP client application and a UPnP device when the UPnP device comes on-line.

FIG. 5 illustrates a flow diagram between the UPnP client application and the UPnP device when the UPnP device goes off-line.

FIG. 6 illustrates a flow chart for a process of UPnP device discovery.

FIG. 7 illustrates a system that employs the discovery technique of the present invention to search target objects through one or more intermediate devices.

FIG. 8 illustrates a block diagram of a computer operable to execute the disclosed architecture.

FIG. 9 illustrates a schematic block diagram of an exemplary computing environment in accordance with the present invention.

### DETAILED DESCRIPTION OF THE INVENTION

The present invention is now described with reference to the drawings, wherein like reference numerals are used to refer to like elements throughout. In the following description, for purposes of explanation, numerous specific details are set forth in order to provide a thorough understanding of the present invention. It may be evident, however, that the present invention may be practiced without these specific details. In other instances, well-known structures and devices are shown in block diagram form in order to facilitate describing the present invention.

As used in this application, the terms “component” and “system” are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers.

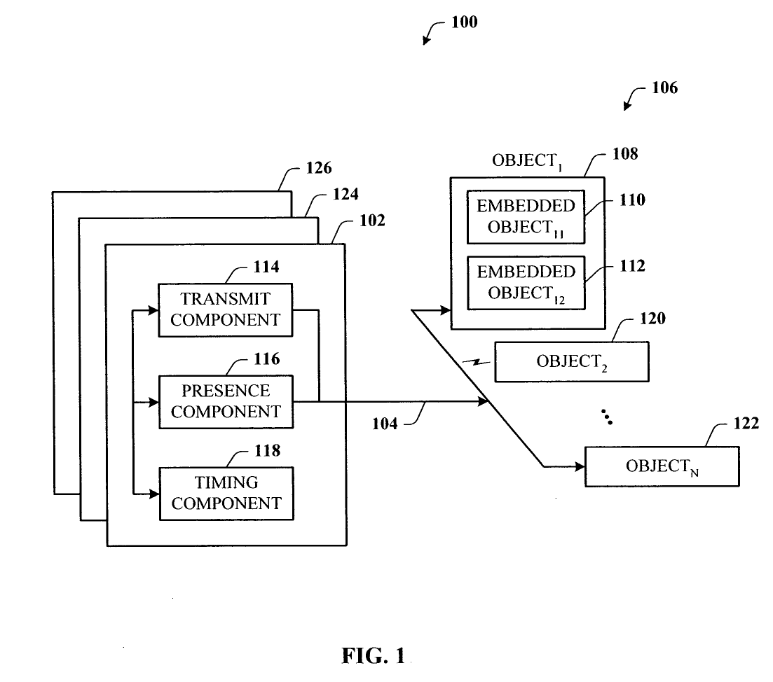

Referring now to FIG. 1, there is illustrated a block diagram of a system 100 communicating in accordance with the present invention. The present invention utilizes a communication protocol in a non-intuitive way by initiating early statusing of one or more target objects before associated standardized signaling events, such as timeouts, occur. In the case of timeouts, the particular protocol may require that objects “report in” according to a predetermined time, for example, every 30 minutes. However, the implementation of many different hardware and software components a networked environment can introduce the need for notifications earlier than the normal signaling events associated with the selected target objects. The present invention allows the requesting hardware and/or software components to request early statusing and/or notification of the one or more target objects “on-demand” according to individual needs of the requesting software and/or hardware.

The system 100 includes at least one control object 102 in communication over a network 104 with one or more target objects 106. The term “object” is intended to include hardware and/or software components. The relationship between the control object 102 and the one or more target objects 106 is such that the control object 102 desires status of the one or more target objects 106.

The object status is at least in the context of whether the one or more target objects 106 are still in an “on-line” or “off-line” state, where on-line and off-line are intended to be in the context of respectively providing or failing to provide the desired software and/or hardware functions. Typically, the target object is off-line when it can no longer communicate with the control object 102. This scenario includes failure of an orderly shutdown where an abrupt failure of the target object occurs while on the network 104, or failure of an orderly disconnect of the target object without signaling its intention to disconnect, both of which impact normal signaling of the target object to the control object 102. However, a target device can be considered to be off-line even thought it can communicate at some level with the control object 102, but the target object is functionally inoperative at the desired level.

Thus, as indicated above, the target object is considered to be on-line with respect to a control object when it is in communication with the control object and functioning at the level sought to be statused. This means that the target object may be considered to be on-line for one desired function, but off-line for another. Where a target object is multifunctional, one function may be totally functional while another function is not. For example, if a first control object is interested only in a hardware status of the target object, and only the desired hardware function is operational, it is on-line with respect to that control object. If a second control object is interested only in a status of specific software running on the target object, which specific software is inoperative while the hardware is functional, the target object is off-line from the perspective of that second control object.

Thus, a first target object 108 (denoted OBJECT₁) can be a hardware device that includes one or more embedded objects, a first target embedded object 110 (denoted EMBEDDED OBJECT₁₁) and a second target embedded object 112 (denoted EMBEDDED OBJECT₁₂). The first embedded object 110 can be an embedded hardware device, and the second embedded object 112 can be software in the form of a service. Of course, the embedded objects (110 and 112) can be only hardware, or only software, or any combination of hardware and software. Moreover, there may be only one embedded object or a plurality of embedded objects. It is further appreciated that the first target object 108 can be strictly software, such that the one or more embedded objects are software subcomponents running within the software object.

The control object 102 further includes a transmit component 114 that transmits a discovery message to the target object 108 in accordance with a hardware and/or software component request generated therefrom, the target object 108 normally, but not necessarily, having a timeout period associated therewith. In the context of the single control object 102 simply needing to know the status of the single target object 108, the on-demand discovery message is in the format of multicast-type message transmitted as a unicast message to the target object 108.

The control object 102 also includes a presence component 116 that monitors the network 104 (e.g., via a port or channel) for a response to the unicast message. If the appropriate response is received from the target object 108, the object 108 is determined to be on-line. However, if a response is not received, the object 108 is presumed to be off-line.

In the context of the single control object 102 desiring status of the single target object 108, and/or one or more embedded objects (110 and/or 112), the on-demand discovery process can include sending one discovery message to the target object 108, in response to which the target object 108 replies with the status of the target object 108 and all embedded objects (110 and 112). Again, this is in the format of the multicast-type message transmitted in unicast to the target object 108.

Alternatively, the status of the target object 108 itself may already be known such that the control object 102 requires the status of one or more of the embedded objects (110 and 112). In this scenario, the control object 102 transmits a discovery message directly to one of the embedded objects (110 or 112), in response to which the targeted embedded object (110 or 112) replies (or fails to reply) in unicast to the control object 102.

Still alternatively, the control object 102 may require the status of all embedded objects (110 and 112), in which case separate discovery messages (using the multicast-type message sent in unicast) are transmitted separately and directly to the respective embedded objects (110 and 112). Each targeted embedded object (110 and 112) will then attempt to respond in unicast, if on-line and operational to do so.

In most cases, the control component 102 can send more than one discovery request signal if the first request went unanswered. This is because datagrams can be dropped in the target object 108 and/or along the network 104 for any number of reasons, such as the network 104 momentarily being disrupted during transmission of the response, a network switching or routing device dropping the message datagram, and power fluctuations related to the powering the target object 108, for example.

In another scenario, many target objects, whether hardware, software, or combinations thereof, are designed to function even when appearing to be off-line with respect to the control object 102. To mitigate such effects, the control object 102 can include a suspend mode that temporarily suspends the processes normally resulting from an initially perceived failure mode of the target object. The suspend mode can then reissue one or more follow-up discovery request messages to the targeted object(s), after which a predetermined number of non-responses, the targeted object is determined to be off-line. This ensures that the response datagram truly represents the state of the targeted object.

In furtherance thereof, the control object 102 also includes a timing component 118 that provides timing information to the control object 102 to facilitate tracking signaling events such as timeout data of the target object 108.

The system 100 of the present invention monitors not only the timeout information, but also dynamically determines when to perform an object discovery. For example, a client application or hardware system associated with the system 100 can drive the need to determine the target object status, in response to which the system 100 transmits the discovery message thereto. Alternatively, a discovery process may be premised on the timeout data such that the control object 102 issues the discovery request based upon when the timeout is due to expire. For example, if a timeout associated with the target object 102 is normally due to expire in 30 minutes, the control object 102 can be configured to send the discovery request every six minutes, or three times before timeout expiration, or at any time based on-demand, as indicate previously.

It is to be appreciated that the network 104 may have disposed thereon additional target objects that include zero, one, or more embedded objects. Accordingly, there is illustrated a second target object 120 (denoted OBJECT₂) disposed in wireless communication with the network 104, and an Nth target object 122 (denoted OBJECT_{N}) disposed thereon.

In accordance wit the present invention, the control object 102 may send discovery messages to each of the target objects 108, 120, and 122 (OBJECT₁, OBJECT₂, . . . , OBJECT_{N}) on an as-needed basis. This means that each target object 108, 120, and 122 may be associated with a different client application such that each different client application initiates discovery at different times to minimize burdening network bandwidth. Alternatively, the applications can be “synchronized” to each send the discovery message to the respective target objects at substantially the same time.

Of course, there may be one or more additional control objects (124 and 126) disposed on the network 104 (and similar to the control object 102) that operate to perform target object statusing in accordance with the present invention, and with some or all of the target objects 108, 120, and 122.

The target object 108, 120, and 122 may include one or more computers disposed in wired and/or wireless communication with the system 100. Note that an object in this context includes at least any software or hardware suitably designed to respond to such communications, including, but not limited to, computers, PDAs, wired/wireless hardware devices, and other software services and applications.

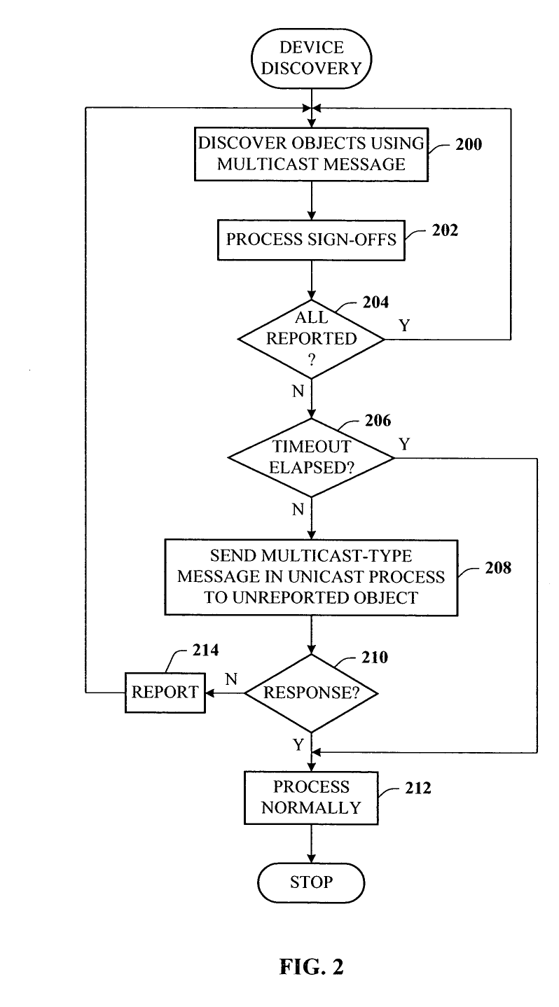

Referring now to FIG. 2, there is illustrated a flow chart of a discovery process in accordance with the present invention. While, for purposes of simplicity of explanation, the one or more methodologies shown herein, e.g., in the form of a flow chart, are shown and described as a series of acts, it is to be understood and appreciated that the present invention is not limited by the order of acts, as some acts may, in accordance with the present invention, occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the present invention.

At 200, target objects are initially discovered or detected using a broadcast (e.g., multicast signal) message. A list or table is then created detailing all of the detected target objects such that at a later time, the list can be used to facilitate tracking the status of such objects. Of course, the list will change as new target objects make their presence known to network entities or previously detected target objects disconnect. At 202, target object sign-offs are processed as the corresponding target objects report in during a orderly disconnect process.

At 204, a determination is made as to whether there are any remaining target objects that need to be addressed. This situation can occur when a target object actually signs off, but the corresponding sign-off datagram or message is not received by the control object that needs this information. For example, the datagram could be dropped by network routing or switching gear, or the communication link therebetween could have been disrupted such that the datagram is dropped or corrupted. If all target objects have reported in, the control object may not need to communicate notification in accordance with novel aspects of the present invention. Flow is then from 204 to 200 to rediscover network objects or nodes according to discovery criteria, which criteria can include an on-demand basis, and/or at predetermined times prior to timeout expiration, for example.

If there are target objects on the list that have not been reconciled with those that have reported in, then these objects may need to be statused. However, this does not necessarily require that the unaccounted for target objects immediately trigger a discovery process. The statusing process also includes processing timeout data associated with one or more of the objects. Thus, if not all of the target objects have reported in, flow is from 204 to 206 to determine if associated timeout data has elapsed. If NO, flow is to 208 to send a multicast-type message in unicast (e.g., send the normally utilized multicast-type message only to the one target object) to prompt a response from the selected target object. At 210, the system determines if a response has been received. If YES, flow is to 212 to process the target object in accordance with the response. The process then reaches a Stop block. If the timeout data has elapsed, flow is from 206 to 212 to then process the target object using the timeout data. Since timeout periods are typically implemented to repeat consecutively, elapse of a first timeout period without the object reporting in may also be configured as a trigger mechanism for initiating an early search message to the associated object in a following second timeout period.

On the other hand, if a response is not received from the selected target object, flow is from 210 to 214 to send a report or notification indicating that the target object has not responded to the discovery request. Flow is then back to 200 perform the discovery process.

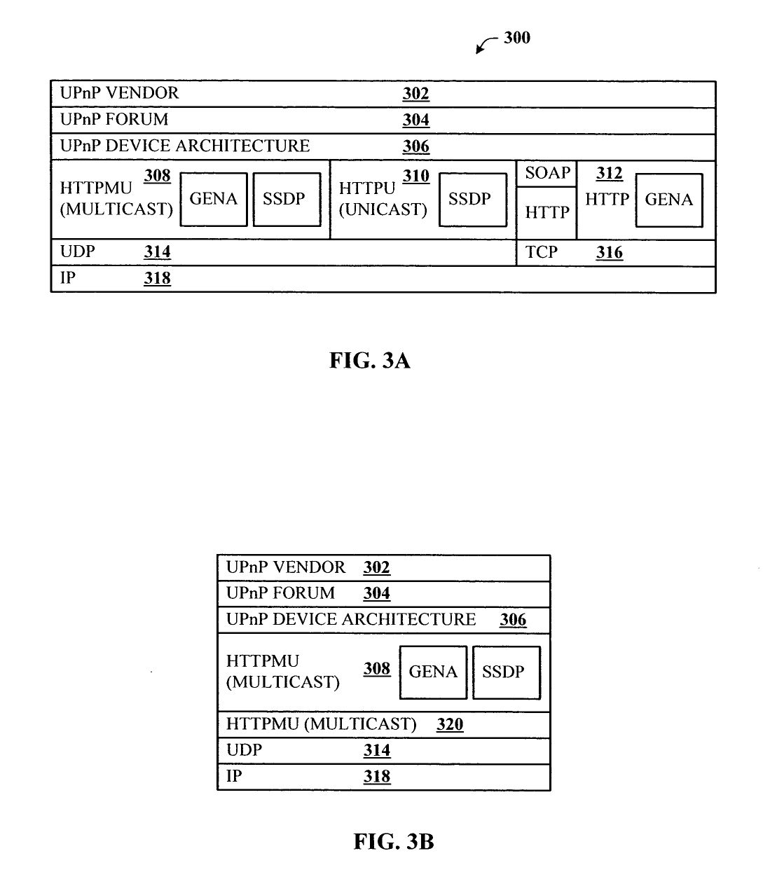

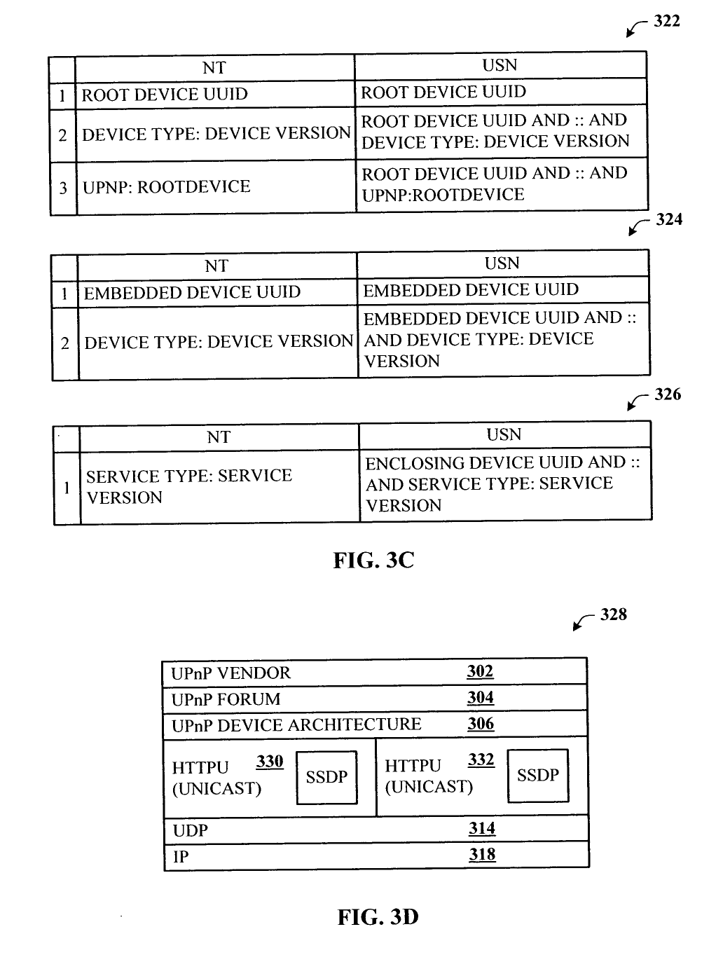

Referring now to FIG. 3A, there is illustrated a protocol stack of a UPnP implementation in accordance with the present invention. The invention can apply to a Universal Plug and Play (UPnP) suite of network protocols, which utilize a Simple Service Discovery Protocol (SSDP) and the General Event Notification Architecture (GENA) notification protocol. The following description is in the context of UPnP specification version 1.0. However, the general novel aspects embodied herein apply not only to the current version but also to later versions thereof, and generally, to any protocol that can be suitably implemented in a non-intuitive way to achieve the same results.

UPnP is an architecture for peer-to-peer network connectivity of intelligent appliances, wireless devices, and PCs, and is designed to bring standards-based connectivity to ad-hoc or unmanaged networks whether in the home, a small business, public spaces, or attached to the Internet. UPnP is a distributed, open networking architecture that leverages TCP/IP (Transmission Control Protocol/Internet Protocol), UDP (User Datagram Protocol), HTTP (HyperText Transfer Protocol), and XML (eXtensible Markup Language) to enable seamless proximity networking. Among other things, UPnP is designed to support automatic discovery of a wide variety of devices or objects and, embedded devices and/or services of these devices or objects. This means that a device can dynamically join a network, obtain an IP address, convey its capabilities, and learn about the presence and capabilities of other devices, embedded devices and services. A device or object can leave the network smoothly and automatically without leaving any unwanted state behind.

UPnP is “universal” in that no device drivers are required. Common protocols are used instead such that devices can be implemented using any programming language, and on any operating system. Contracts are based on wire protocols that are declarative, expressed in XML, and communicated via HTTP.

The UPnP architecture defines the protocols for communication between controllers (e.g., hardware and/or client software applications) and devices. For discovery, description, control, eventing, and presentation, UPnP uses the protocol stack 300 of FIG. 3A. At a highest layer 302 (e.g., a Vendor layer), messages logically contain only UPnP vendor-specific information about corresponding devices. Below the Vendor layer 302 is a UPnP Forum layer 304 where vendor content is supplemented by information defined by UPnP Forum working committees. Messages from the layers above are hosted in UPnP-specific protocols. In turn, the above messages are formatted using the SSDP, GENA, and Simple Object Access Protocol (SOAP). The above messages are delivered via HTTP, either a multicast or unicast variety running over UDP, or the standard HTTP running over the TCP. Ultimately, all messages above are delivered using IP. It is to be appreciated that the disclosed architecture is not limited to the disclosed protocols, but also finds application using any network protocols, including NetBEUI.

The foundation for UPnP networking is IP addressing. Each target object has a Dynamic Host Configuration Protocol (DHCP) client, and searches for a DHCP server when it is first connected to the network. If a DHCP server is available (e.g., the network is managed), the object uses the IP addressed assigned to it. If no DHCP server is available (e.g., the network is unmanaged) the object uses Auto-IP to get an address, where Auto-IP defines how a device intelligently chooses an IP address from a set of reserved addresses and is able to move easily between managed and unmanaged networks. If during the DHCP transaction, the object obtains a domain name, e.g., through a DNS (Domain Name Server) system or via DNS forwarding, the object uses that name in subsequent network operations; otherwise, the object uses its IP address.

Given an IP address, discovery can occur. When a new object is added to the network, it multicasts a number of discovery messages advertising its embedded devices and services to control objects on the network. Any interested control object can listen to the standard multicast address for notifications that new capabilities are available. Similarly, when a control object is added to the network, the UPnP discovery protocol allows that control object to search for target objects of interest on the network by multicasting a discovery message searching for interesting devices, services, or both. The fundamental exchange in both cases is a discovery message containing a few essential specifics about the device or one of its services, e.g., its type, identifier, and a pointer to more detailed information. All object listen to the standard multicast address for these messages and respond if any of their embedded devices or services match the search criteria in the discovery message.

Referring now to FIG. 3B, there is illustrated a subset of the UPnP protocol stack 300 of FIG. 3A used to send and receive advertisements in accordance with the present invention. When a device and/or service is added to the network, the UPnP discovery protocol allows the device and/or service to advertise itself and/or its services by broadcasting discovery messages to a standard address and port. The object broadcasts a number of discovery messages corresponding to each of its embedded devices and services. If the object (control or target) becomes unavailable, the object will explicitly cancel its advertisements. If the object becomes disabled and is unable to cancel its advertisement, the advertisements will expire on their own.

According to the protocol subset, UPnP vendor-specific information is at the highest layer 302. The UPnP forum layer 304 supplements the vendor content, e.g., device type. The layers 302 and 304 are hosted in UPnP-specific protocols by the device architecture layer 306. All of the information for layers 302, 304, and 306 are delivered via a multicast variant of a HTTP layer 320, using an extension of the HTTP with GENA methods and headers and SSDP headers, as indicated at layer 308. The UDP layer 314 indicates that the HTTP messages are delivered via UDP over IP, as further indicated by the layer 318.

Referring now to FIG. 3C, there is illustrated a subset of the UPnP protocol stack of FIG. 3A used to advertise characteristics of the target object in accordance with the present invention. As indicated hereinabove, each object connected to the network may further contain an embedded device and one or more services. These are advertised to the network. Thus, an object multicasts a number of messages to advertise its capabilities, the messages comprising the following: a root device message 322; an embedded object message 324; and, an embedded object message 326. Each message 322, 324, and 326 includes an NT (Notification Type) header required by GENA and a USN (Unique Service Name) header required by GENA.

The root device message 322 of the root device includes three discovery messages. The first root device message includes a root device UUID (Universally Unique Identifier) for both the NT and USN headers. The second root device message includes a device type and a device version for both the NT and USN headers with an additional root device UUID for the USN header. The third root device message includes UPnP rootdevice data for both the NT and USN headers, with the root device UUID additionally for the USN header.

The embedded object message 324 includes two discovery messages for each embedded object. As before, the embedded object message 324 includes both the NT and USN headers. A first embedded object message, for a device, for example, includes the embedded device UUID for both the NT and USN headers. The second embedded object message includes the device type and device version for both the NT and USN headers with an additional embedded device UUID for the USN header.

There is one object message 326 for each embedded service. The service message includes both the NT and USN headers, as before, but also a service type and a service version for both the NT and USN headers. The USN header also has associated therewith an enclosing device UUID.

When an object is added to the network, it sends a multicast request with method NOTIFY and ssdp:alive in the NTS header in the following format. Values in italics are placeholders for actual values.

NOTIFY * HTTP/1.1
HOST: 239.255.255.250:1900
CACHE-CONTROL: max-age=seconds until advertisement expires
LOCATION: URL for UPnP description for root device
NT: search target
NTS: ssdp:alive
SERVER: OS/version UPnP/1.0 product/version
USN: advertisement UUID

When an object (control or target) and/or its services are going to be removed from the network, the object multicasts an ssdp:byebye message corresponding to each of the ssdp:alive messages it multicasted previously, and that have not already expired, thereby properly revoking its earlier announcements and effectively declaring that its embedded devices and services will not be available. Each multicast request has method NOTIFY and ssdp:byebye in the NTS (Notification Sub Type) header in the following format.

NOTIFY * HTTP/1.1
HOST: 239.255.255.250:1900
NT: search target
NTS: ssdp:byebye
USN: advertisement UUID

If the object is removed abruptly from the network, it may not be possible to timely revoke a previous multicast message. As a fallback position, discovery messages include an expiration value in a CACHE-CONTROL header. If not re-advertised, the discovery message eventually expires on its own and is removed from any control object cache.

UPnP control object applications track the presence of a target object using a fixed coarse time period, for example, with a granularity no smaller than thirty minutes. The novel aspects of the present invention allow any correctly functioning UPnP object to respond to an on-demand discovery request from the control object at any time before the fixed time. For example, this technique can be applied to the Windows XP® browser protocol, which has a “request announcement” protocol element.

Referring now to FIG. 3D, there is illustrated a sample UPnP protocol stack 328 used to send a multicast-type discovery datagram in unicast in accordance with the present invention. UPnP vendor-specific information is at the highest layer 302, e.g., client applications, device, and service identifiers. The UPnP forum layer 304 supplements the vendor content, e.g., device or service types. The layers 302 and 304 are hosted in UPnP-specific protocols by the device architecture layer 306. Here the discovery request is delivered via a unicast variant of an HTTP layer 330 that uses an extension using SSDP methods headers. The discovery response is delivered via a unicast variant of an HTTP layer 332 that has also been extended with SSDP. The UDP layer 314 indicates that the HTTP data (330 and 332) is delivered via UDP over IP, as further indicated by the layer 318.

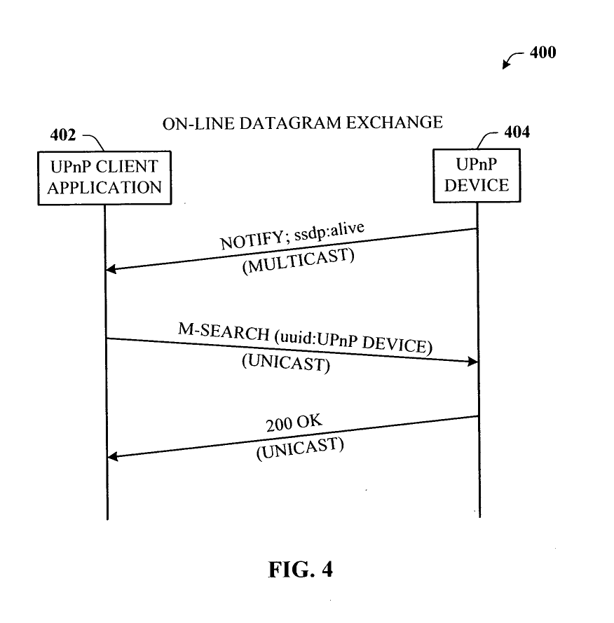

Referring now to FIG. 4, there is illustrated a flow diagram 400 between a UPnP client application 402 and a UPnP device 404 when the UPnP device 404 comes on-line. For discovery, the client 402 uses a GENA NOTIFY verb transmitted over the HTTP protocol. When the device 404 first comes on-line, and periodically thereafter in accordance with its timeout data, it issues a GENA NOTIFY command, with the ssdp:alive notification type in multicast to notify all active nodes of its presence on the network. In this example, the UPnP device 404 issues the ssdp:alive notification indicating that it is currently on-line. The UPnP client application 402, which may be running on a PC, then discovers that the device 404 is on-line.

During normal operation thereafter, and in accordance with novel aspects of the present invention, the client 402 may require notification from the device 404 earlier than its associated timeout. If the client application 402 requires that there be a more timely notification, then the following is applied by the application 402 to determine if the device 404 is currently active on the network. UPnP specifies an M-SEARCH verb that allows the UPnP client 402 to search for the UPnP device 404. Normally, this M-SEARCH verb is sent as a broadcast (e.g., a multicast datagram) to discover multiple devices. However, it is not desirable to transmit the message as multicast, since it would unnecessarily burden the network by transmitting the message to all devices in the multicast group. Additionally, the messages to multiple destination devices are more likely to be discarded by routers.

However, in accordance with the present invention, it is possible to use the protocol in a non-intuitive way by sending the normally multicast M-SEARCH verb as a unicast datagram directly to the destination device 404. At some point after the client application 402 has come on-line, it decides that it needs to determine if the UPnP device 404 is still on-line, and issues an M-SEARCH request specifying a uuid (universally unique identifier) of the UPnP device 404. The destination device 404 receives the M-SEARCH verb on its port and, believing it to be a general request for the device, treats it as if it was a broadcast M-SEARCH request. The device 404 then responds with a proper directed search response of “2000K” (e.g., a unicast response) indicating that it is on-line. Thus, the normally multicast M-SEARCH request can be made to function as an Internet Control Message Protocol (ICMP) ping operation.

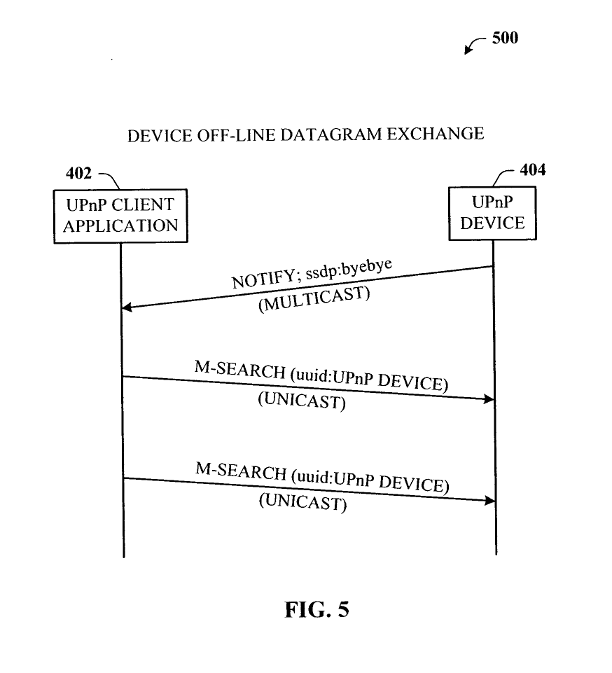

Referring now to FIG. 5, there is illustrated a flow diagram 500 between the UPnP client application 402 and the UPnP device 404 when the UPnP device 404 goes off-line. When the device 404 goes off-line, it is supposed to issue another GENA NOTIFY command with the ssdp:byebye notification type. If the device 404 is unable to send the ssdp:byebye command or if the datagram containing the ssdp:byebye command is discarded by the network before reception by the client 402, then the client application 402 will not detect that the device 404 has gone off-line until the full thirty-minute timeout period has expired.

In this embodiment, after the device has gone on-line, the device fails and becomes disabled or unplugged before an orderly shutdown or disconnect can occur, e.g., the device is a smart appliance that catches fire and the user pulls the power plug. As a result, the appliance is unable to send the ssdp:byebye announcement that would tell the client 402 that the appliance is no longer on-line. Once again, the client application 402 wishes to determine if the appliance is still on-line. It sends the directed M-SEARCH multicast-type message request to the device 404. This time, since the appliance is not on-line, the appliance will not respond to the request, and thus the client application 402 will be able to determine that the appliance is not present. As a backup, a second or even a third follow-up directed M-SEARCH request can be sent in accordance with predetermined backup messaging criteria until it is determined with some degree of certainty that the appliance is off-line.

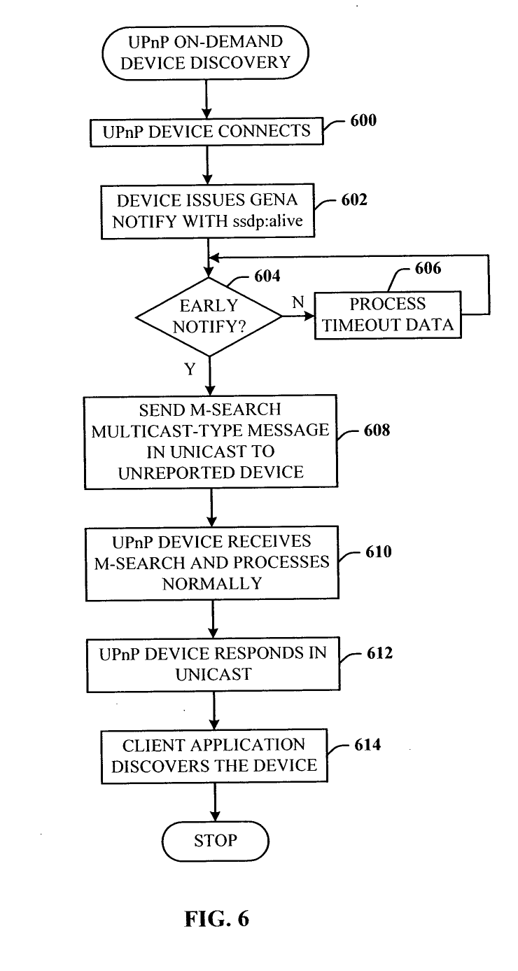

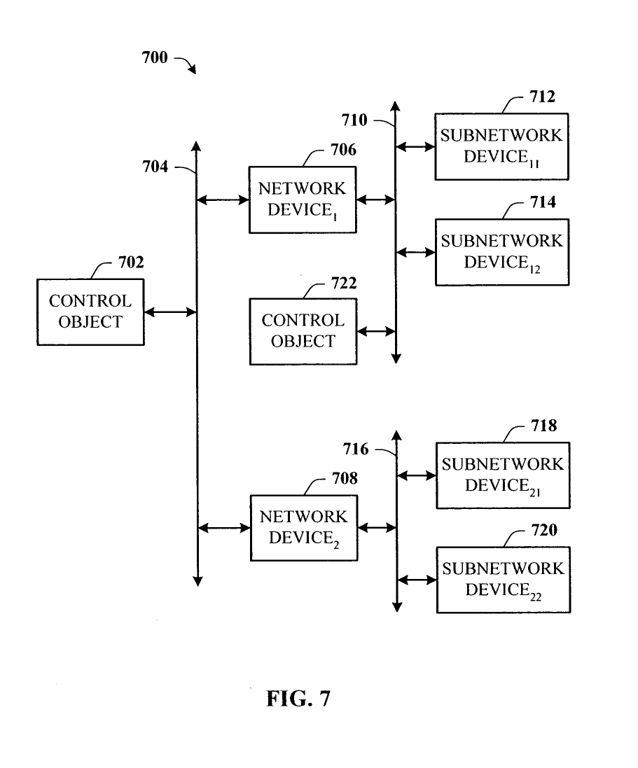

Referring now to FIG. 6, there is illustrated a flow chart for a process of UPnP device discovery. At 600, a UPnP device connects to the network. In a wired regime, the connection process can include making the physical wired connection, powering up the device, and allowing the device intelligence to bring the software to a state that facilitates announcing the presence of the device on the network. In either or both of a wired and a wireless regime, this may further include facilitating authentication and authorization procedures to ensure the device will only be allowed connection to the appropriate network. At 602, the device issues a GENA notify with ssdp:alive notification type. At 604, it is determined if an early notify is required by the client application. If NO, flow is to 606 to process the associated timeout data. Flow then loops back to the input of 604 to determine if early notification is again requested.

If early notification is required by the client application, flow is from 604 to 608 where the client application sends a UPnP M-SEARCH multicast-type message in unicast to the device the should have reported in. At 610, the UPnP device receives the M-SEARCH message and processes it normally, by responding in unicast, as indicated at 612. At 614, the client application then discovers the device. The process then reaches a Stop block.

It is to be appreciated that if the device fails to respond, the client application may issue the multicast message in unicast, more than once. This pinging process may continue for a predetermined number of times until it is determined with some degree of certainty that the device is off-line.

Referring now to FIG. 7, there is illustrated a system 700 that employs the discovery technique of the present invention to search target objects through one or more intermediate devices. Here, there target objects include network and subnetwork devices. There is provided a first control object 702 disposed on a network 704 in communication with a first network device 706 (also denoted NETWORK DEVICE₁) and a second network device 708 (also denoted NETWORK DEVICE₂). The first and second network devices 706 and 708 may each be a router, switch, or gateway device that facilitates transmitting data packets between various networks and subnetworks. Here, the first network device 706 further communicates with a first subnetwork 710 (also called a “subnet”) on which a first subnet device 712 (also denoted SUBNETWORK DEVICE ₁₁) and a second subnet device 714 (also denoted SUBNETWORK DEVICE₁₂) are disposed. The second network device 708 further communicates with a second subnet 716 on which a third subnet device 718 (also denoted SUBNETWORK DEVICE₂₁) and a fourth subnet device 720 (also denoted SUBNETWORK DEVICE₂₂) are disposed.

The control object 702 needs to ascertain the status of the subnet devices 712, 714, 718, and 720. Of course, the networks 704, 710, and 716 can accommodate significantly more network and target devices then are illustrated, and which can be searched in accordance with aspect of the present invention. Moreover, there can exist many more control objects on the network 704, and on the networks 710 and 718 that require statusing information. For example, there can be a second control object 722 disposed on the first subnet 710 that requires local statusing of the subnet devices 712 and 714, and remote statusing of the third and fourth subnet devices 718 and 720.

The first control object 702 (similar to control object 102) requires frequent status information about either or both of the first and second subnet devices 712 and 714. The status information is obtained on demand for one or more client applications and/or devices of the first control object 702. Thus, when required, the control object 702 sends the multicast-type message in unicast to the selected target object, first subnet device 712, for example. Accordingly, if on-line and operational, the device 712 receives and processes the discovery request, believing it to be a multicast request, and responds to the first control object 702 with success response in unicast. In one implementation, receipt of the discovery request by the first subnet device 712 invokes a response therefrom that details all of its embedded devices and services. In another implementation, the discovery request is directed only to the subnet device 712, and not to the embedded devices and services. In still another embodiment, the request is directed to only one of the embedded objects, invoking a unicast response from that embedded object to the control object 702.

It is conceivable, however, that the intermediary first network device 706 is queried with the novel discovery request by the control object 702, and operable to process and respond accordingly. Thus, if the selected target object, subnet device 712, fails to respond to the on-demand discovery request, the control object 702 may be configured to drop back a level and begin testing the one or more intermediary devices, here, network device 706, to determine its status. As described previously, many devices will continue to operate normally even if the network fails. If the status of the network device 706 is failure (or off-line), processing of the discovery request for the subnet device 712 can be held in abeyance until the true state of the device 712 is known with some degree of certainty.

The intermediate network device 706 is operable to advertise and discover in accordance with the disclosed architecture. Thus, in another alternative implementation, the network device 706 can be configured to behave in a certain way to a predetermined number of discovery requests. For example, is the control object 702 transmitted two consecutive discovery requests, using the disclosed multicast-type message in unicast, this can be interpreted by the network device 706 to proxy the discovery request to the subnet device 712. If determined to be on-line, the network device 706 will then forward this on-line information to the control object 702.

In another implementation, the network device 706 can simply route through the discovery request(s) to the addressed subnet device 712. Here, the subnet device 712 can be configured to behave differently in response to receiving a predetermined number or sequence of discovery requests. For example, if three discovery requests were sent to the device 712, it could trigger the device 712 to stay on-line for another fixed period of time. Alternatively, it could trigger a response that facilitates troubleshooting the device, for example, toggles message transmissions between its embedded device and an embedded service. The flexibility offered is limited only by the capabilities of the control and target devices to process more sophisticated strings of discovery requests and to act accordingly.

It is to be appreciated that the novel discovery technique of the present invention may by implemented with a classifier system that learns and adapts to the status of devices and the network over time. That is, the importance of devices, data, and networks, for example, may be factored in to impact how the classifier is utilized to rank and prioritize operation of the network and statusing of the desired devices. For instance, without a classifier, the control object 702 can include a client application that requires statusing of the first and second subnet devices 712 and 714 routinely well before the associated timeouts expire causing automatic status advertising to occur. Of course, if the first subnet device 712 performs one or more operations or is associated with a function that is deemed to be much more important than those of the second subnet device 714, the client application can be programmed accordingly to request more frequent statusing of the first device 714 in accordance with the importance of the subnet devices.

When utilizing the classifier in cooperative communication and control with the control object, the behavior of the relationship between the control object and one or more of the target objects can be adaptively modified over time. Moreover, as additional target objects are connected or existing target objects are disconnected from the subnet 710, such actions can be monitored to impact operation of the statusing relationship between the control object and the target objects. The relationship can be defined, in one example, based upon network conditions. Thus, if the network is exhibiting a more erratic behavior that impacts the quality or integrity of datagrams exchanged during the discovery and/or announcements processes, the classifier can increase the frequency of searches for the desired target object to more frequently ascertain its status. As the network stabilizes, the search frequency can then be relaxed to not transmit search requests as frequently.

In an alternative implementation, consider a group or aggregation of interdependent devices and/or services where the failure of any one service impacts the remaining services. In a worst case, the failure of one of the devices and/or services causes the remaining devices and/or services to fail. Such an interdependent aggregation of devices and/or services finds failure of one service to cause a cascading effect that brings down the remaining devices and/or services according to a series of events. In such an implementation, the discovery process of the present invention can be utilized to send discovery requests in a certain order or hierarchy to first determine that the most important service (or most vulnerable to failure of condition(s)) is active, then the second most important, and so on down the line. Where one or more of the services are associated with timeouts, such that expiration of the timeout results in shutdown of the service, the disclosed discovery protocol can further be utilized to signal one or more of the services to stay “alive” for a predetermined amount of time or timeout periods. As indicated previously, such a signal can include a predetermined string of discovery signals transmitted to the target service (or object) to stay alive for a timeout period, or for several timeout periods, even though all indications are that the service should shutdown. This can also be considered to be override signal where the target service is configured to interpret the string of discovery signals as a certain command, such as to override the current timeout period for a duration of time.

As a further implementation in accordance with the previous implementation, the target objects may be redundantly employed, such that the failure of the primary target service automatically causes an identical secondary service to be brought on-line to alleviate the cascading failure of the aggregate services. Alternatively, perhaps the secondary service is a more robust service employed with the preconceived knowledge that if the primary service has failed the more robust services will be employed to facilitate troubleshooting and diagnosis of the current failure condition.

One such application of the disclosed invention contemplates browsers where a master browser broadcasts announcement requests to a network of computers that utilize one or more other browsers. Once all other browsers have reported in, the master browser can then direct a discovery message in accordance with the novel discovery protocol to select ones of the other browsers, when desired.

In another implementation, the discovery protocol is used to “ping” the target object to obtain its status. If the status is offline, the control object can then announce to the network the offline status of the target. Other clients can then update their target list accordingly without burdening the network bandwidth with separate discovery requests for each client. However, where such capabilities are implemented, appropriate safeguards need to be put in place to prevent abuse thereof, e.g., associated with a denial-of-service attack.

In still another implementation, discovery responses can be cached in the control object such that devices and/or services associated therewith need not burden the network with additional searches when the search may have already been performed and the result cached in the control object. This is particularly advantageous on lower speed networks where repeated discovery requests burden the bandwidth. Where the network architecture does not utilize a keep-alive signal that can be sent to the target object to signal it to stay in-line, such caching facilitates obtaining the target status without having to repeatedly perform a new search.

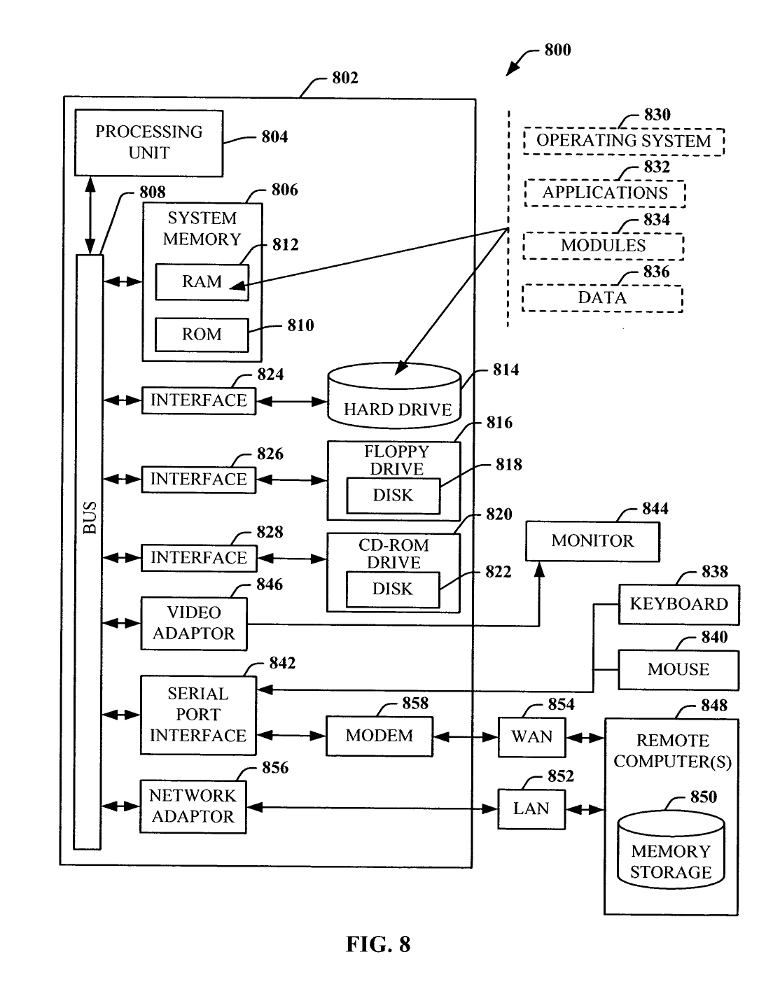

Referring now to FIG. 8, there is illustrated a block diagram of a computer operable to execute the disclosed discovery protocol architecture. In order to provide additional context for various aspects of the present invention, FIG. 8 and the following discussion are intended to provide a brief, general description of a suitable computing environment 800 in which the various aspects of the present invention may be implemented. While the invention has been described above in the general context of computer-executable instructions that may run on one or more computers, those skilled in the art will recognize that the invention also may be implemented in combination with other program modules and/or as a combination of hardware and software. Generally, program modules include routines, programs, components, data structures, etc., that perform particular tasks or implement particular abstract data types. Moreover, those skilled in the art will appreciate that the inventive methods may be practiced with other computer system configurations, including single-processor or multiprocessor computer systems, minicomputers, mainframe computers, as well as personal computers, hand-held computing devices, microprocessor-based or programmable consumer electronics, and the like, each of which may be operatively coupled to one or more associated devices. The illustrated aspects of the invention may also be practiced in distributed computing environments where certain tasks are performed by remote processing devices that are linked through a communications network. In a distributed computing environment, program modules may be located in both local and remote memory storage devices.

With reference again to FIG. 8, there is illustrated an exemplary environment 800 for implementing various aspects of the invention that includes a computer 802, the computer 802 including a processing unit 804, a system memory 806 and a system bus 808. The system bus 808 couples system components including, but not limited to, the system memory 806 to the processing unit 804. The processing unit 804 may be any of various commercially available processors. Dual microprocessors and other multi-processor architectures may also be employed as the processing unit 804.

The system bus 808 can be any of several types of bus structure that may further interconnect to a memory bus (with or without a memory controller), a peripheral bus, and a local bus using any of a variety of commercially available bus architectures. The system memory 806 includes read only memory (ROM) 810 and random access memory (RAM) 812. A basic input/output system (BIOS) is stored in a non-volatile memory 810 such as ROM, EPROM, EEPROM, which BIOS contains the basic routines that help to transfer information between elements within the computer 802, such as during start-up. The RAM 112 can also include a high-speed RAM such as static RAM for caching data.

The computer 802 further includes a hard disk drive 814, a magnetic disk drive 816, (e.g., to read from or write to a removable disk 818) and an optical disk drive 820, (e.g., reading a CD-ROM disk 822 or to read from or write to other high capacity optical media such as Digital Video Disk (DVD)). The hard disk drive 814, magnetic disk drive 816 and optical disk drive 820 can be connected to the system bus 808 by a hard disk drive interface 824, a magnetic disk drive interface 826 and an optical drive interface 828, respectively. The drives and their associated computer-readable media provide nonvolatile storage of data, data structures, computer-executable instructions, and so forth. For the computer 802, the drives and media accommodate the storage of broadcast programming in a suitable digital format. Although the description of computer-readable media above refers to a hard disk, a removable magnetic disk and a CD, it should be appreciated by those skilled in the art that other types of media which are readable by a computer, such as zip drives, magnetic cassettes, flash memory cards, digital video disks, cartridges, and the like, may also be used in the exemplary operating environment, and further that any such media may contain computer-executable instructions for performing the methods of the present invention.

A number of program modules can be stored in the drives and RAM 812, including an operating system 830, one or more application programs 832, other program modules 834 and program data 836. It is appreciated that the present invention can be implemented with various commercially available operating systems or combinations of operating systems. All or portions of the operating system, applications, modules, and/or data can also be cached in the RAM 812. Here, the operating system, applications, and modules include one or more client applications suitable to facilitate transmission of the multicast-type message in unicast to the object and receipt of the unicast response from the object.

A user can enter commands and information into the computer 802 through a keyboard 838 and a pointing device, such as a mouse 840. Other input devices (not shown) may include a microphone, an IR remote control, a joystick, a game pad, a satellite dish, a scanner, or the like. These and other input devices are often connected to the processing unit 804 through a serial port interface 842 that is coupled to the system bus 808, but may be connected by other interfaces, such as a parallel port, a game port, a universal serial bus (“USB”), an IR interface, etc. A monitor 844 or other type of display device is also connected to the system bus 808 via an interface, such as a video adapter 846. In addition to the monitor 844, a computer typically includes other peripheral output devices (not shown), such as speakers, printers etc.

The computer 802 may operate in a networked environment using logical connections via wired and/or wireless communications to one or more remote computers, such as a remote computer(s) 848. The remote computer(s) 848 may be a workstation, a server computer, a router, a personal computer, portable computer, microprocessor-based entertainment appliance, a peer device or other common network node, and typically includes many or all of the elements described relative to the computer 802, although, for purposes of brevity, only a memory storage device 850 is illustrated. The logical connections depicted include a local area network (LAN) 852 and a wide area network (WAN) 854. Such networking environments are commonplace in offices, enterprise-wide computer networks, intranets and the Internet.

When used in a LAN networking environment, the computer 802 is connected to the local network 852 through a wired or wireless communication network interface or adapter 856. The adaptor 856 may facilitate wired or wireless communication to the LAN 852, which may also include a wireless access point disposed thereon for communicating with the wireless adaptor 856. When used in a WAN networking environment, the computer 802 typically includes a modem 858, or is connected to a communications server on the LAN, or has other means for establishing communications over the WAN 854, such as the Internet. The modem 858, which may be internal or external and a wired or wireless device, is connected to the system bus 808 via the serial port interface 842. In a networked environment, program modules depicted relative to the computer 802, or portions thereof, may be stored in the remote memory storage device 850. It will be appreciated that the network connections shown are exemplary and other means of establishing a communications link between the computers may be used.

The computer 802 is operable to communicate with any wireless devices or entities operably disposed in wireless communication, e.g., a printer, scanner, desktop and/or portable computer, portable data assistant, any piece of equipment or location associated with a wirelessly detectable tag (e.g., a kiosk, news stand, restroom), and telephone. This includes at least Wi-Fi and Bluetooth™ wireless technologies. Thus, the communication may be a predefined structure as with conventional network or simply an ad hoc communication between at least two devices.

Wi-Fi, or Wireless Fidelity, allows connection to the Internet from a couch at home, a bed in a hotel room or a conference room at work, without wires. Wi-Fi is a wireless technology like a cell phone that enables such devices, e.g., computers, to send and receive data indoors and out; anywhere within the range of a base station. Wi-Fi networks use radio technologies called IEEE 802.11 (a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, with an 11 Mbps (802.11b) or 54 Mbps (802.11a) data rate or with products that contain both bands (dual band), so the networks can provide real-world performance similar to the basic 10BaseT wired Ethernet networks used in many offices.

The disclosed computer 802 may also be employed with HiperLAN technology. HiperLAN is a set of wireless local area network (WLAN) communication standards primarily used in European countries. There are two specifications: HiperLAN/1 and HiperLAN/2, both of which have been adopted by the European Telecommunications Standards Institute. The HiperLAN standards provide features and capabilities similar to those of the IEEE 802.11 WLAN standards used in the U.S. and other adopting countries. HiperLAN/1 provides communications at up to 20 Mbps in the 5-GHz range of the radio frequency spectrum. HiperLAN/2 operates at up to 54 Mbps in the same RF band, and is compatible with 3G (third-generation) WLAN systems for sending and receiving data, images, and voice communications. HiperLAN/2 has the potential, and is intended, for implementation worldwide in conjunction with similar systems in the 5-GHz RF band.

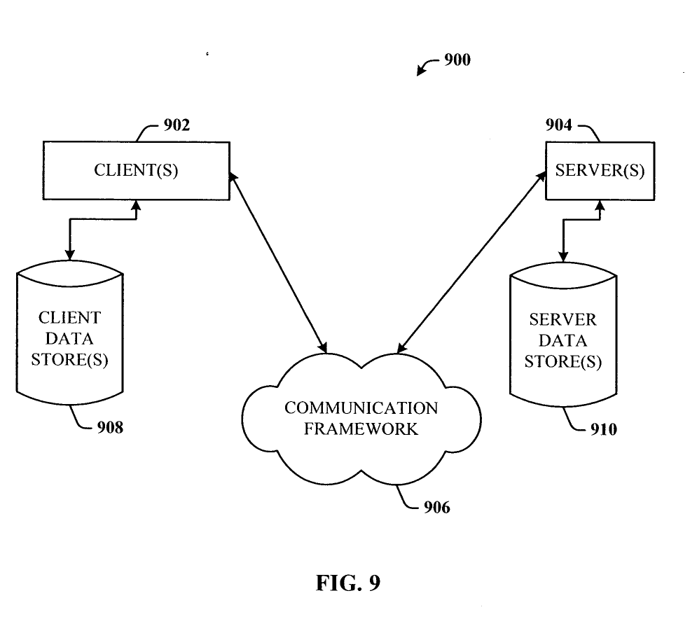

Referring now to FIG. 9, there is illustrated a schematic block diagram of an exemplary computing environment 900 in accordance with the present invention. The system 900 includes one or more client(s) 902. The client(s) 902 can be hardware and/or software (e.g., threads, processes, computing devices). The client(s) 902 can house cookie(s) and/or associated contextual information by employing the present invention, for example. The system 900 also includes one or more server(s) 904. The server(s) 904 can also be hardware and/or software (e.g., threads, processes, computing devices). The servers 904 can house threads to perform transformations by employing the present invention, for example. One possible communication between a client 902 and a server 904 may be in the form of a data packet adapted to be transmitted between two or more computer processes. The data packet may include a cookie and/or associated contextual information, for example. The system 900 includes a communication framework 906 (e.g., a global communication network such as the Internet) that can be employed to facilitate communications between the client(s) 902 and the server(s) 904.

Communications may be facilitated via a wired (including optical fiber) and/or wireless technology. The client(s) 902 are operably connected to one or more client data store(s) 908 that can be employed to store information local to the client(s) 902 (e.g., cookie(s) and/or associated contextual information). Similarly, the server(s) 904 are operably connected to one or more server data store(s) 910 that can be employed to store information local to the servers 904.

What has been described above includes examples of the present invention. It is, of course, not possible to describe every conceivable combination of components or methodologies for purposes of describing the present invention, but one of ordinary skill in the art may recognize that many further combinations and permutations of the present invention are possible. Accordingly, the present invention is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

1. A system that facilitates determining presence of an object, comprising:
a transmit component that transmits a multicast-type message as a unicast message to the object, the object having a timeout period associated therewith; and
a presence component that monitors a response to the unicast message from the object, and if a response is not received, the object is presumed to be off-line.

2. The system of claim 1, the object is at least one of a wired device, a wireless device, and a service.

3. The system of claim 1, the multicast-type message is transmitted in unicast at least once before the timeout period expires.

4. The system of claim 1, a plurality of the multicast-type messages are transmitted in unicast to the object to control the object.

5. The system of claim 4, the plurality of multicast-type messages signal the object to stay online.

6. The system of claim 1, at least one of the transmit component and the presence component is part of a client application that transmits the multicast-type message in unicast and receives the response in unicast form the object.

7. The system of claim 1, the object is disposed on a network remote from the transmit and presence components.

8. The system of claim 1, the unicast response is cached at the system-end.

9. The system of claim 1, the multicast-type message is directed to at least one of the object, an embedded device of the object, and an embedded service of the object.

10. The system of claim 1, the multicast-type message is sent a predetermined number of times before the object is determined to be off-line.

11. The system of claim 1, the object is compatible with a plug-and-play architecture.

12. The system of claim 1, the transmit component transmits a plurality of unique multicast-type messages in unicast to a respective plurality of the objects.

13. The system of claim 1, the transmit component transmits a first multicast-type message in unicast to an intermediate device to determine its status before transmitting the multicast-type message in unicast to the object.

14. The system of claim 1, the multicast-type message is transmitted in unicast to the object from a first client application, the response to which indicates a status of the object, and the status of which is announced by the first client application to a second client application.

15. A computer system according to claim 1.

16. A computer readable medium having stored thereon computer executable instructions for carrying out the system of claim 1.

17. A system that facilitates determining presence of an object, comprising:
a client application that seeks status of the object; and
a discovery component associated with the client application that facilitates discovery of the object via a discovery protocol, the protocol comprising:
transmitting a multicast-type message as a unicast message to the object, the object having a timeout period associated therewith; and
checking for receipt of a response from the object to determine the status thereof.

18. The system of claim 17, the client application signals the discovery component to initiate discovery of the object by transmitting the multicast-type message in unicast to the object.

19. The system of claim 17, the discovery component is part of the client application.

20. The system of claim 17, the client application is a master browser seeking the status of a plurality of other browsers.

21. The system of claim 17, the discovery protocol is based upon a universal plug-and-play architecture that uses at least one of a simple service discovery protocol and a general event notification architecture protocol.

22. The system of claim 17, the discovery protocol utilizes a network protocol.

23. The system of claim 22, the network protocol comprises at least one of TCP/IP, HTTP, NetBEUI, and XML.

24. The system of claim 17, the discovery component operates to discover one or more of the objects according to a predetermined hierarchy.

25. The system of claim 17, wherein receipt of a response in unicast indicate that the object is on-line and non-receipt of a response indicates that the object is off-line.

26. A method of determining the presence of an object on a network, comprising:
transmitting a multicast-type message in unicast to the object on demand;
checking for receipt of a response from the object to determine the status of the object; and
determining the status of the object based upon receipt or non-receipt of the response.

27. The method of claim 26, further comprising delaying determination of the status of the object until a predetermined number of additional multicast-type messages have been transmitted to the object in unicast.

28. The method of claim 26, further comprising initiating discovery of an intermediary object in response to determining initially that the object is off-line.

29. The method of claim 26, further comprising automatically initiating discovery of a redundant object in response to determining that the object is off-line.

30. The method of claim 26, the object is one of a plurality of interdependent objects such that failure of the object results in failure of the remaining plurality of interdependent objects.

31. The method of claim 30, plurality of interdependent objects are discovered according to a hierarchy such that the object is discovered before the remaining plurality of interdependent objects.

32. The method of claim 26, further comprising signaling the object to stay on-line using at least two of the multicast-type messages sent in unicast to the object.

33. A system that determines the presence of an object on a network, comprising:
means for monitoring a timeout associated with the object;
means for transmitting a multicast-type message in unicast to the object on demand before the timeout expires;
means for checking for receipt of a response from the object to determine the status of the object; and
means for determining the status of the object based upon receipt or non-receipt of the response.

34. The system of claim 33, further comprising means for caching the status of the object for access by a client application.

35. The system of claim 33, further comprising means for determining a network condition that causes the means for transmitting to transmit the multicast-type message in unicast more frequently based upon worsening network conditions, and to relax the frequency of transmission when the network resume more normal operation.

36. A computer-readable medium having computer-executable instructions for performing a method for determining the presence of an object on a network, the method comprising:
transmitting a multicast-type message in unicast to the object on demand;
checking for receipt of a response from the object to determine the status of the object; and
determining the status of the object based upon receipt or non-receipt of the response.
